(19) United States
(12) Patent Application Publication
(10) Pub. No.: US 2021/0140606 A1
(43) Pub. Date: May 13, 2021

(54) WIDE BEAM ANGLE CREATION FOR SOLID STATE LIGHTING

(71) Applicant: SIGNIFY HOLDING B.V., EINDHOVEN (NL)

(72) Inventor: Oliver DROSS, EINDHOVEN (NL)

(21) Appl. No.: 16/492,874

(22) PCT Filed: Mar. 26, 2018
(86) PCT No.: PCT/EP2018/057575

§ 371 Date: Sep. 10, 2019

(30) Foreign Application Priority Data
Apr. 3, 2017 (EP) 17164500.5

(51) Int. Cl. F21V 5/08; F21V 5/04; G02B 27/30; F21V 5/00

(52) U.S. Cl. CPC F21V 5/08; F21V 5/004; G02B 27/30; F21V 5/046

(57) ABSTRACT

Disclosed is a lens plate (10) comprising a plurality of polygonal aspherical lenslets (11) each defined around a Voronoi point (13), said polygonal lenslets combining to form a Voronoi tessellation, wherein each polygonal lenslet includes a rotationally symmetric portion (15) centered on its Voronoi point and an aspherical surface (21) with a continually decreasing curvature from the surface vertex (25) of said rotationally symmetrical portion towards its edges (17). Such a lens plate is capable of generates wide beam angles, e.g. beam angles in excess of 30° at FWHM of the beam with high optical efficiency. Also disclosed is an optical arrangement including such a lens plate, a lighting device including such an optical arrangement and an apparatus including such a lighting device.

### FIELD OF THE INVENTION

The present invention relates to a lens plate comprising a plurality of polygonal aspherical lenslets each defined around a Voronoi point, said polygonal lenslets combining to form a Voronoi tessellation.

The present invention further relates to an optical arrangement including such a lens plate, a lighting device including such an optical arrangement and an apparatus including such a lighting device.

### BACKGROUND OF THE INVENTION

With a continuously growing population, it is becoming increasingly difficult to meet the world's energy needs and, simultaneously, to control carbon emissions to kerb greenhouse gas emissions which are considered responsible for global warming phenomena. These concerns have triggered a drive towards a more efficient use of electricity in an attempt to reduce energy consumption.

One such area of concern is lighting applications, either in domestic or commercial settings. There is a clear trend towards the replacement of traditional, relatively energy-inefficient, light bulbs such as incandescent or fluorescent light bulbs with more energy efficient replacements. Indeed, in many jurisdictions the production and retailing of incandescent light bulbs has been outlawed, thus forcing consumers to buy energy-efficient alternatives, e.g. when replacing incandescent light bulbs.

A particularly promising alternative is provided by solid state lighting (SSL) devices, which can produce a unit luminous output at a fraction of the energy cost of incandescent or fluorescent light bulbs. An example of such a SSL element is a light emitting diode (LED). Such SSL devices furthermore benefit from an increased robustness compared to traditional light sources, thereby dramatically increasing their operational lifetime.

However, a major challenge that needs to be addressed for the successful replacement of traditional light sources with such SSL devices is to ensure that the luminous output produced by such SSL devices has the desired distribution, e.g. to ensure that the luminous output resembles that of a traditional light source to be replaced.

For example, where the desired luminous distribution is a spotlight beam having a defined beam angle, a lighting device based on SSL elements typically comprises one or more optical elements to shape the luminous distribution of the SSL elements into such a spotlight beam. A common approach is to collimate such a luminous distribution, which collimated distribution subsequently is angularly spread in order to create a spotlight beam having a particular beam angle. Such angular spreading for example may be achieved by a scattering the light passing through the light exit surface of a collimator by means of roughening the light exit surface. This is a cost-effective manner of achieving such beam spreading but has the major drawback of poor controllability; it is difficult to control the degree of scattering introduced by such surface roughening. Also, due to unavoidable back scattering effects, well-defined large beam angles practically are impossible to obtain using scattering techniques.

For this reason, an often preferred solution is to use a single sided micro-lens array comprising a plurality of micro-lenses (lenslets) to convert the collimated light produced with the collimator into the spotlight beam with the desired beam angle. Such an array can be also referred to as a lens plate. Solutions are known in which the lens plate is (spatially) separated from the collimator or forms an integral part of the collimator, e.g. defines a light exit surface of the collimator. Because of the available tooling for faceting, the surfaces of such lenslets usually are spherical in nature. The beam angle achieved with such a lens plate can be controlled by varying at least one of the lenslet density, type of tessellation for the lenslets on the lens plate and the radius of curvature of the lenslets.

However, a problem associated with such lens plates is that it is difficult to achieve relatively large beam angles, e.g. beam angles in excess of 30° at full width half maximum (FWHM) of the beam, with high optical efficiency. This is because higher beam angles can be achieved by reducing the radius of curvature of the lenslets, but this comes at the cost of higher total internal reflection (TIR) at off-axis angles (i.e. light incident on the spherical lenslet surface under a non-zero angle with its optical axis), in particular at relatively large off-axis angles. Such TIR reduces the optical efficiency of the lens plate and can increase optical artefacts such as glare and colour separation in the beam formed with the lens plate.

US 2006/0238876 A1 discloses an optics array for beam shaping, which uses a micro-lens combination including polygonal micro-lenses, typically spherical micro-lenses. The geometric arrangement of the individual lenses and their diameters follow a Voronoi distribution pattern in which the surface vertex of each micro-lens is displaced relative to the Voronoi point of its polygonal area. However, such an optics array still suffers from TIR at off-axis angles.

### SUMMARY OF THE INVENTION

The present invention seeks to provide a lens plate for shaping collimated light into a beam having a beam angle at FWHM of the beam in excess of 30° with improved optical efficiency.

The present invention further seeks to provide an optical arrangement including such a lens plate, a lighting device including such an optical arrangement and an apparatus including such a lighting device.

According to an aspect, there is provided a lens plate comprising a plurality of polygonal aspherical lenslets each defined around a Voronoi point, said polygonal lenslets combining to form a Voronoi tessellation, wherein each polygonal lenslet includes a rotationally symmetric portion centered on its Voronoi point and an aspherical surface with a continually decreasing curvature from the surface vertex of said rotationally symmetrical portion towards its edges, wherein each rotationally symmetric portion typically has a radius rmin defined by the distance between the Voronoi point and the nearest edge of the lenslet, wherein the lenslets extend from a common plane, and each lenslet has its surface vertex located at a distance in a range of 0.2-1.0 mm from said common plane, and wherein each lenslet has an average radius ravg and a radius of curvature R at its surface vertex, wherein the ratio R/ravg is in a range of 0.5-3.0.

The present invention is based on the insight that aspherical lenslets having a continually decreasing curvature, i.e. having a surface shape that is becoming increasingly aspherical at larger off-axis angles, effectively suppresses TIR at such off-axis angles such that the lenslets may be shaped to achieve a higher angular spread of incident collimated light in order to achieve such larger beam angles without suffering significant TIR and associated optical artefacts.

In order to achieve beam angles in excess of 30° at the FWHM of the beam, each lenslet has its surface vertex located at a distance in a range of 0.2-1.0 mm from a common plane from which the lenslets extend. This distance is also commonly referred to as sag, i.e. the lenslets have an amount of sag in the aforementioned range. In addition, each lenslet has an average radius r_{avg} and a radius of curvature R at its surface vertex, wherein the ratio R/r_{avg} is in a range of 0.5-3.0. It has been found that particularly where both the lenslet sag and the ratio r/R are within the aforementioned ranges, a lens plate is obtained that can produce beam angles in excess of 30° at the FWHM of the beam, e.g. up to 45°, or even up to 70° without significant optical losses caused by off-axis TIR effects.

In order to effectively suppress such off-axis TIR effects, the aspherical surface may comprise an inclined linear surface section meeting at least one of its edges. In at least some embodiments, the inclined linear surface section defines a region of the lenslet delimited by its average radius and its maximum radius. In other words, the inclined linear surface section may begin at a distance from the surface vertex of the rotationally symmetric portion corresponding to the average radius of the lenslet and may extend towards one or more edges of the polygonal lenslet where such edges lie at a distance from the surface vertex that is greater than the average radius of the lenslet in order to ensure that incident light at off-axis angles such that the light is incident on the aspherical lenslets surface region at a distance greater than the average radius of the lenslet does not significantly suffer from TIR at such a surface region. It is furthermore noted that the higher the degree of collimation incident on the lens plate, the smaller the amount of off-axis illumination of the lens plate becomes, which assists in obtaining larger beam angles as the maximum off-axis angles of the incident light determines the achievable maximum FWHM of the spot beam produced with the lens plate.

The aspherical surface, e.g. the inclined linear surface section, may have a surface normal at each of the edges of the lenslet under an angle in a range of 10-40° with the optical axis of the rotationally symmetric portion in order to achieve the desired optical performance of the lens plate.

The aspherical surface may be spherical at the surface vertex.

In a preferred embodiment, the respective aspherical surfaces of the lenslets have the same continually decreasing curvature, which ensures that no step exists between neighbouring polygonal lenslets. This facilitates the manufacturing of the lens plate in a cost-effective manner. The aspherical surface may be defined by a function f that is continuous in its second derivative (f″) in order to produce a smooth intensity distribution with the lens plate as is desirable in illumination applications.

According to another aspect, there is provided an optical arrangement comprising the lens plate of any of the herein described embodiments and a collimator, wherein the collimator is arranged to couple collimated light into the lens plate. Such an optical arrangement is capable of producing relatively large beam angles, e.g. in excess of 30°, with high optical efficiency, which for example is advantageous in shaping the luminous output of light sources based on SSL elements.

The lens plate may be spatially separated from the collimator or may be mounted on a light exit surface of the collimator. Alternatively, the lens plate may be integral to the collimator, which has the advantage that only a single optical component needs to be provided, which may reduce the overall cost of the optical arrangement. In such an arrangement, the lenslets of the lens plate may extend from a planar surface or alternatively may extend from a curved surface, i.e. the lens plate may be curved.

In an embodiment, the lenslets of the lens plate face the collimator such that the lenslets act as the light entry surface of the lens plate. In this arrangement, even larger beam angles may be generated with good optical efficiency.

According to yet another aspect, there is provided a lighting device comprising a light source including at least one solid state lighting element and the optical arrangement of any of the herein described embodiments, wherein the light source is positioned relative to the collimator such that the collimator collimates the luminous output of the light source onto the lens plate. Such a lighting device may be configured to produce relatively large beam angles, e.g. in axis of 30°, with high optical efficiency.

In an embodiment, the lighting device is a light bulb such as a MR 16, GU10, AR111 or a PAR light bulb. Other sized light bulbs of course are equally feasible. The lighting device according to embodiments of the present invention may be applied in any application domain in which wide-angle beams are required, such as workspace lighting, retail lighting, and so on.

The lighting device may form part of an apparatus for providing illumination mounted over a workspace or the like as an auxiliary function of the apparatus. For example, such an apparatus may be an extractor fitted over a cooker or the like, an oven, a wall-mounted electronic device in which the lighting device is arranged to provide illumination below the electronic device, and so on.

### BRIEF DESCRIPTION OF THE DRAWINGS

Embodiments of the invention are described in more detail and by way of non-limiting examples with reference to the accompanying drawings, wherein:

FIG. 1 schematically depicts a lens plate according to an embodiment of the present invention;

FIG. 2 schematically depicts an aspect of such a lens plate in more detail, with FIG. 2A showing a further detail;

FIG. 3 schematically depicts example curvature functions for the lenslets of a lens plate according to embodiments of the present invention;

FIG. 4 schematically depicts a lighting device according to an embodiment; and

FIG. 5 schematically depicts a lighting device according to another embodiment.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

FIG. 1 schematically depicts a lens plate 10 according to an embodiment of the present invention. The lens plate 10 is shown to have a polygonal outline, e.g. a rectangular shape such as a square shape, by way of non-limiting example only. The lens plate 10 may have a circular shape instead. More generally speaking, the lens plate 10 may have any suitable shape. It is noted for the avoidance of doubt that the outline of the beam generated with the lens plate 10 is governed by the (average) shape of the lenslets 11, as will be readily understood by the skilled person.

The lens plate 10 comprises a plurality of lenslets 11 defining a tessellated surface, e.g. a light exit surface, of the lens plate 10. The tessellated surface typically exhibits a Voronoi distribution, which distribution preferably is a non-symmetrical distribution of polygonal domains, e.g. a pseudo-random distribution. As is well-known per se, a Voronoi distribution can be numerically generated by definition of a plurality of Voronoi points 13 on a surface, from which for each Voronoi point 13 all points are calculated that are closer to the Voronoi point 13 then to any of the other of Voronoi points 13. This collection of points defines the polygonal domains, i.e. the lenslets 11, with the edges or boundaries 17 between the lenslets 11 defining the points that are equidistant to the Voronoi points 13 of the domains bisected by such an edge or boundaries 17, as indicated by the dashed double arrow in FIG. 1.

The lens plate 10 may be designed by superimposing a rotationally symmetric lens design onto each of the Voronoi points 13 such that the surface vertex of the lens design as well as the Voronoi point 13 lie on the optical axis of the lens design. In other words, the focal points of the lens designs coincide with the Voronoi points 13. It is noted for the avoidance of doubt that a surface vertex 25 is the point of the lens surface coinciding with the optical axis 23 of the lenslet 11 (see FIG. 2). Such a lens design typically has a diameter of at least the largest distance between any of the Voronoi points 13 and one of the edges of the domain in which that Voronoi point 13 is located such that it is ensured that the lens design fully covers each of these domains. Such superposition of the lens design onto the respective Voronoi points 13 leads to an intermediate design with overlapping lens designs. This overlap is removed in accordance with the defined edges 17, i.e. the overlap between the respective lens designs positioned onto the Voronoi points 13 defines the edges 17, to yield the design of the lens plate 10. Consequently, each lenslet 11 of the lens plate 10 comprises a rotationally symmetric portion 15, which rotationally symmetric portion typically has a radius rₘᵢₙ defined by the distance between the Voronoi point 13 onto which the corresponding lens design was placed and the nearest edge 17 of the lenslet 11.

In addition, where identical lens designs are used for the respective Voronoi points 13, this arrangement ensures that the lens plate 10 does not contain steps between neighboring lenslets when the lenslets 11 extend from a common plane as in such a scenario the equidistant nature of the edge 17 from the respective Voronoi points 13 of such neighboring lenslets 11 ensures that the two lens designs meet at the same height above this common plane at the edge 17. Consequently, by using identical lens designs for the respective lenslets 11 of the lens plate 10, a lens plate 10 is provided that can be manufactured in a straightforward and cost-effective manner due to the fact that no steps need to be manufactured between neighboring lenslets 11. However, it should be understood that embodiments of the present invention are not limited to lens plates in which all lenslets 11 share the same lens design; it is equally feasible that different lenslets 11 have different lens designs, which different lens designs all obey the lens design rules as explained in the present application.

In particular, all lenslets 11 of the lens plate 10 comprise an aspherical surface 21 as schematically depicted in FIG. 2. The aspherical surface 21 has a continually decreasing curvature from the surface vertex 25 of the rotationally symmetrical portion 15 of the lenslet 11 towards its edges 17. In a preferred embodiment, the aspherical surface 21 may be defined by a function f that is continuous in its second derivative (f″) in order to produce a smooth intensity distribution with the lens plate 10 as is desirable in illumination applications. The decreasing curvature of the aspherical surface 21 has the purpose of suppressing TIR at light hitting the aspherical surface 21 in off-axis locations, where a lenslet with a relatively high curvature may cause such TIR effects due to the light hitting the off-axis surface portion under angles in excess of the critical angle, which as is well-known per se is governed by the difference in the refractive index of the lens material of the lenslet 11 and the medium in contact with the aspherical surface 21, typically air. The decreasing curvature of the aspherical surface 21 towards the edges 17 of the lenslet 11 increases the critical angle for such off-axis regions of the aspherical surface 21, such that the lenslets 11 may be used to convert collimated light into diverging spotlights having a relatively wide beam angle, such as a beam angle in excess of 30°, e.g. a beam angle in a range of 30° -45° without suffering from significant optical losses an artefact generation due to TIR in off-axis regions of the lenslet surface 21.

In order to achieve such relatively large beam angles (at FWHM of the generated beam), each lenslet 11 preferably has a sag 29 in the range of 0.2-1.0 millimetres, wherein the sag 29 is defined as the distance between the surface vertex 25 of the lenslet 11 and the common plane 20 from which the lenslets 11 extend. In addition, each lenslet 11 preferably has a relative radius of curvature in the range of 0.5 to 3.0, wherein the relative radius of curvature is defined as the ratio R/r_{avg}, wherein r_{avg} is the average radius of the lenslet 11 and R is the radius of curvature of the aspherical surface 21 at the surface vertex 25, which may approximate a spherical surface at this point. In other words, R is the radius of the sphere defining the spherical surface portion at the surface vertex 25. It has been found by the inventor that in particular when such small radii are combined with high sag values, a large spreading of incident light can be achieved without the lens plate then suffering from optical losses and artefacts due to TIR. It is noted at this point that the average radius of a lenslet 11 is defined as the average of all radii of the lenslet 11 to its respective edges 17.

As will be readily understood by the skilled person, this design parameters may be controlled by the provision of an appropriate lens design, e.g. an appropriate rotationally symmetric lens design and the definition of a set of Voronoi points 13 on the common surface 20 such that the resulting Voronoi distribution ensures that the sag 29 of each of the lenslets 11 lies within the aforementioned range. In this respect, it is noted that the amount of sag 29 of a lenslet 11 typically will be defined by the curvature of the aspherical surface 21 of the lens design and the distance rₘₐₓ of the Voronoi point 13 to the furthest edge 17 of the Voronoi domain to which this point belongs. Hence, any Voronoi distribution that is obtained from a given set of Voronoi points 13 may be checked against the lens design to be used to check if upon placement of the lens design (or lens designs) on the respective Voronoi points 13 the sag 29 of each of the lenslets 11 lies within this range. If this is not the case, the set of Voronoi points 13 may be rejected and a new set of Voronoi points 13 may be generated from which another Voronoi distribution can be generated. This process may be implemented by numerical approximation, with the approximation terminating upon the provision of a Voronoi distribution obeying the provided design constraints of the lens plate 10.

In order to suppress such TIR at off-axis locations of the aspherical lenslet surface 21, the surface normal 28 of an off-axis section 27 of the aspherical surface 21 at the edges 17 of the lenslet 11 preferably is oriented under an angle θ with the optical axis 23 in a range of 10-40°, as schematically depicted in FIG. 2A. This angle typically is chosen close to the critical angle to ensure maximised spreading of incident light without the occurrence of TIR, and the angle may be optimized as a function of the desired beam spreading angle to be achieved with the lens plate 10 as will be readily understood by the skilled person. This is further explained with the aid of FIG. 3, which depicts four different rotationally symmetrical lens designs A-D (only half of each lens design is shown for the sake of clarity). Each of these lens designs obeys the design rules of the present invention in that each lens design defines an aspherical surface 21 having a continually decreasing curvature (curvature z on the y-axis) in the direction away from its optical axis 23 (distance r on the x-axis), but wherein the curvature is increasing from design A to design D in order to create spotlights with increasing beam angles.

In an embodiment, the off-axis section 27 of the aspherical surface 21 may approximate a linear surface portion of the aspherical surface 21. For example, the off-axis section 27 may become straight (flat) in the surface region of the aspherical surface 21 in between the average radius r_{avg} (with the dotted line indicated by r_{avg} being the asymptote to a circle having radius r_{avg}) and the maximum radius rₘₐₓ of the lenslet 11 as schematically depicted in FIG. 2 to suppress TIR in these off-axis regions of the lenslet surface 21. This further ensures that the maximum radius rₘₐₓ of the lenslet 11 may significantly extend beyond the average radius r_{avg} of the lenslet 11, e.g., rₘₐₓ≥1.3* r_{avg}, whilst ensuring that the sag 29 of the lenslet 11 remains within the desired range as previously explained. However, it should be understood that this linear surface portion may extend towards the optical axis 23 beyond the average radius r_{avg} of the lenslet 11, e.g. up to or even beyond rₘᵢₙ. Also, it should be understood that this surface portion is not necessarily linear; instead, it may remain some decreasing curvature towards the edges 17 of the lenslet 11. For the sake of clarity aspherical surfaces 21a are given of adjacent lenslets 11 which respectively border (intersect) the instant aspherical surface 21 at rₘᵢₙ, r_{avg}, and rₘₐₓ.

At this point, it is noted that the lens plate 10 may be made of any suitable material, such as glass or optical grade polymer such as polycarbonate, polyethyl terephthalate, poly(methyl methacrylate), and so on. It is furthermore noted that although the lens plate 10 is shown to have convex lenslets 11, it is equally feasible that the lens plate 10 comprises concave lenslets 11. The common plane 20 of the lens plate 10 may act as a seed or mounting surface of the lens plate 10 onto which the lenslets 11 are formed. Although lenslets 11 are shown on a single major surface of the lens plate 10, it is equally feasible that the opposing major surfaces of the lens plate 10 both carry lenslets 11, e.g. convex lenslets 11. Although the lenslets 11 are shown on a light exit surface of the lens plate 10, in an alternative embodiment the lenslets 11 are formed on a light entry surface of the lens plate 10, which enables the generation of spot beams with even larger beam angles, e.g. up to 70° at FWHM of such a beam. It further should be understood that the common plane 20 may be replaced by a curved surface without departing from the teachings of the present invention.

FIG. 4 schematically depicts a lighting device 1 according to an example embodiment. The lighting device 1 typically comprises an optical arrangement 40 including the lens plate 10 as previously described and a collimator 30. In addition, the lighting device 1 comprises a light source 50, typically a light source comprising one or more SSL elements, e.g. white light LEDs. The optical arrangement 40 and the light source 50 may be placed within a housing (not shown) of the lighting device 1, which housing may further comprise one or more electronic components such as a ballast or driver of the light source 50 as well as a connector for connecting the light source 50 to a power supply, for example in embodiments in which the lighting device 1 is a lightbulb. Where the lighting device 1 is a lightbulb, the lighting device 1 may be any suitable type of lightbulb, e.g. a spotlight bulb such as a MR 11, MR 16, GU 5.3, GU10, PAR, AR 111 lightbulb and so on. The lighting device 1 in some embodiments may be a luminaire in which the lightbulb is integrated, such as a spotlight luminaire or any other type of luminaire designed to generate a wide-angle spotlight.

The collimator 30 is typically positioned relative to the light source 1 such that the luminous distribution generated by the light source 1 incident on the light entry surface 31 of the collimator 30 is collimated by the collimator 30, such that collimated light exit the collimator 30 at its light exit surface 33 as indicated by the dashed arrows. It should be understood that this light exiting the collimator 30 does not need to be perfectly collimated; in the context of the present application where reference is made to collimated light this include luminous distributions having a divergence of less than 10°. It is furthermore noted that although the collimator 30 is depicted as a Fresnel-type collimator in FIG. 4, it should be understood that this is by way of non-limiting example only and that any suitable type of collimator 30 may be used in the optical arrangement 40 and the lighting device 1.

The lens plate 10 is positioned relative to the collimator 30 such that the lens plate 10 receives the collimated light exiting the collimator 30 through its light exit surface 33 at its light entry surface 20, e.g. the common plane 20 from which the respective lenslets 11 extend, with the lenslets 11 converting the collimated light into a divergent beam having a beam angle at FWHM of the divergent beam preferably in the range of 30-45°. As previously explained, the specific design of the lenslets 11 facilitates the generation of such relatively wide beam angles without significant optical losses through TIR. The respective aspherical surfaces 21 of the lenslets 11 of the lens plate 10 may act as the light exit surface of the optical arrangement 40 and of the lighting device 1 when the optical arrangement 40 is positioned within such a lighting device, although it should be understood that further optically transmissive elements, e.g. a cover plate or the like, may also be present.

In FIG. 4, the lens plate 10 is spatially separated from the collimator 30 by a distance d, which distance may be optimised as a function of the optical requirements of the optical arrangement 40, e.g. within the lighting device 1. Alternatively, the distance d may be zero, i.e. the lens plate 10 may be mounted on the light exit surface 33 of the collimator 30. In a further embodiment, schematically depicted in FIG. 5, the lens plate 10 may be integral to the collimator 30 such that the optical arrangement 40 comprises a single optical element in which the light from the light source 50 is collimated and subsequently spread (by the lens plate 10) to form a divergent beam with the aforementioned beam angles.

The lighting device 1 according to one or more embodiments of the present invention may be advantageously included in a luminaire such as a holder of the lighting device, e.g. a ceiling light fitting, or an apparatus into which the lighting device is integrated, e.g. a cooker hood or the like.

It should be understood that where in the foregoing reference has been made to specific parameters such as angle of incidence, beam angles and lenslet curvatures, this parameters are valid for dielectric materials having a refractive index of around 1.5, e.g. standard glasses, optical grade polymers such as polycarbonate, PET, PMMA and the like. For dielectric materials having a refractive index significantly deviating from 1.5, such parameters may be adjusted accordingly, as will be immediately apparent to the skilled person.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lens plate comprising a plurality of polygonal aspherical lenslets each defined around a Voronoi point, said polygonal lenslets combining to form a Voronoi tessellation, wherein each polygonal lenslet includes a rotationally symmetric portion centered on its Voronoi point and an aspherical surface with a continually decreasing curvature from the surface vertex of said rotationally symmetrical portion towards its edges,
wherein each rotationally symmetric portion typically has a radius rₘᵢₙ defined by the distance between the Voronoi point and a nearest edge of the lenslet,
wherein the lenslets extend from a common plane, and each lenslet has its surface vertex located at a distance in a range of 0.2-1.0 mm from said common plane, and
wherein each lenslet has an average radius r_{avg} and a radius of curvature R at its surface vertex, wherein the ratio R/r_{avg} is in a range of 0.5-3.0.

2. The lens plate of claim 1, wherein the aspherical surface comprises an inclined linear surface section meeting with least one of its edges.

3. The lens plate of claim 1, wherein said inclined linear surface section encompasses a region of the lenslet delimited by its average radius r_{avg} and its maximum radius rₘₐₓ.

4. The lens plate of claim 1, wherein said aspherical surface has a surface normal at each of the edges of the lenslet under an angle in a range of 10-40° with the optical axis of the rotationally symmetric portion.

5. The lens plate of claim 1, wherein said aspherical surface is spherical at the surface vertex.

6. The lens plate of claim 1, wherein the respective aspherical surfaces of the lenslets have the same continually decreasing curvature.

7. The lens plate of claim 1, wherein the aspherical surface is defined by a function f that is continuous in its second derivative f″.

8. An optical arrangement comprising the lens plate of claim 1 and a collimator, wherein the collimator is arranged to couple collimated light into the lens plate.

9. The optical arrangement of claim 8, wherein the lens plate is mounted on a light exit surface of the collimator.

10. The optical arrangement of claim 8, wherein the lens plate is integral to the collimator.

11. The optical arrangement of claim 9, wherein the lens plate is curved.

12. The optical arrangement of claim 9, wherein the lenslets of the lens plate face the collimator.

13. A lighting device comprising a light source including at least one solid state lighting element and the optical arrangement of claim 8, wherein the light source is positioned relative to the collimator such that the collimator collimates the luminous output of the light source onto the lens plate, optionally wherein the lighting device is a light bulb.

14. An apparatus comprising the lighting device of claim 13.
